(19) United States
(12) Patent Application Publication
(10) Pub. No.: US 2025/0377546 A1
(43) Pub. Date: Dec. 11, 2025

(54) ELECTRONIC DEVICE SECUREMENT BAND

(71) Applicant: Apple Inc., Cupertino, CA (US)

(72) Inventors: Daniel A. Henneh, San Jose, CA (US); Megan Grant, San Francisco, CA (US); John S. Camp, Los Gatos, CA (US); Michael E. Savery, San Francisco, CA (US); Samuel O. Schneider, Sacramento, CA (US)

(21) Appl. No.: 18/985,465

(22) Filed: Dec. 18, 2024

Related U.S. Application Data
(60) Provisional application No. 63/658,439, filed on Jun. 11, 2024.

(51) Int. Cl. G02B 27/01; G02C 3/00

(52) U.S. Cl. CPC G02B 27/0176; G02C 3/003

(57) ABSTRACT

A head-mounted display device can include a display assembly including a window, and a light source configured to produce content displayed at the window. In some examples, The head-mounted display device can also include a securement band defining a closed loop, the closed loop including a first connection point, a second connection point, and a third connection point. In some examples, the head-mounted display device can also include a first connection arm coupling the display assembly to the first connection point.

### CROSS-REFERENCE TO RELATED APPLICATION

This application claims the benefit of U.S. Provisional Patent Application No. 63/658,439, filed 11 Jun. 2024, and entitled “ELECTRONIC DEVICE SECUREMENT BAND,” the entire disclosure of which is hereby incorporated by reference.

### FIELD

The described embodiments relate generally to wearable electronic devices. More particularly, the present embodiments relate to head-mountable display devices and securement methods thereof.

### BACKGROUND

Recent advances in portable computing have led to a surge in head-mountable display devices. These devices offer a wide range of applications, from entertainment and gaming to augmented reality experiences that enhance the user's physical environment. However, a major hurdle to widespread adoption of head-mountable display devices is user comfort. Existing designs often concentrate bulky processing units, batteries, and display components directly in front of the user's eyes. This weight distribution can cause discomfort to the user during extended use. Therefore, what is needed in the art is a head-mountable display device that is adjustable and changes the weight distributions exerted on the head of a user.

### SUMMARY

In at least one example of the present disclosure, a head-mounted display device can include a display assembly including a window, and a light source configured to produce content displayed at the window. In some examples, the head-mounted display device can also include a securement band defining a closed loop, the closed loop including a first connection point, a second connection point, and a third connection point. In some examples, the head-mounted display device can also include a first connection arm coupling the display assembly to the first connection point. In some examples, the head-mounted display device can also include a second connection arm coupling the display assembly to the second connection point. In some examples, the head-mounted display device can also include a third connection arm coupling the display assembly to the third connection point. In some examples, the second connection point is opposite the first connection point, and the third connection point is located between the first connection point and the second connection point.

In some examples, a first portion of the securement band including the third connection point is more rigid than a second portion of the securement band adjacent the first portion. In some examples, the head-mounted display device the position of the window can be adjustable relative to the securement band via at least one of the first connection arm, the second connection arm, or the third connection arm. In some examples, the display is cantilevered from the securement band via the first connection arm. In some examples, a tension of the securement band is adjustable. In some examples of the head-mounted display device, the closed loop includes a first material, and at least one of the first connection point, the second connection point, or the third connection point can include a second material more rigid than the first material. In some examples, the head-mounted display device can also include a light seal extending from the securement band. Other technical features can be readily apparent to one skilled in the art from the following figures, descriptions, and claims.

In at least one example of the present disclosure, a securement band for a head-mounted display device can include a loop. In some examples, the securement band can also include a first side connector adjustably coupled to the loop and extending to a display portion. In some examples, the securement band can also include a second side connector adjustably coupled to the loop and extending to the display portion. In some examples, the securement band can also include a front connector adjustably coupled to the loop and extending to the display portion. In some examples, the securement band can also include where the second side connector is disposed opposite the first side connector, and the front connector is disposed between the first side connector and the second side connector.

In some examples, the securement band can also include where the loop includes a continuous loop. In some examples, the loop includes a first portion, and a second portion more elastic than the first portion. In some examples, the loop includes an electronic component. In some examples, at least one of the first side connector or the second side connector cantilevers the display assembly from the loop. In some examples, an adjustment of the front connector changes an angle of the display portion relative to the loop. In some examples, at least one of the first side connector, the second side connector, or the front connector includes an electronic component. Other technical features can be readily apparent to one skilled in the art from the following figures, descriptions, and claims.

In at least one example of the present disclosure, an electronic display device can include a display assembly including a frame and a display coupled to the frame, a securement band configured secure the display assembly to a head, a first side connector adjustably coupling the display assembly to the securement band, a second side connector opposite the first side connector adjustably coupling the display assembly to the securement band, and a front connector adjustably coupling the display assembly to the securement band. In some examples, the first side connector and the second side connector are each translatable in a first direction relative to the securement band.

In some examples, the electronic display device can also include where the first side connector and the second side connector are each configured to support a greater portion of a weight of the display assembly than the front connector. In some examples, the first side connector and the second side connector are rotatable and translatable relative to the securement band. Other technical features can be readily apparent to one skilled in the art from the following figures, descriptions, and claims. In some examples, the display is cantilevered from the securement band via the second connection arm. In some examples, the front connector is translatable in a second direction substantially perpendicular to the first direction relative to the securement band.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a front perspective view of an example of a head-mounted display device;

FIG. 1B shows a rear perspective view of an example of a head-mounted display device;

FIG. 2 shows a top view of an electronic display device;

FIG. 3 shows a side view of an example of a head-mounted display device;

FIG. 4A shows a side view of another example of an electronic display device in one position;

FIG. 4B shows a side view of another example of an electronic display device in another position;

FIG. 5A shows a side view of another example of an electronic display device; and

FIG. 5B shows a side view of yet another example of an electronic display device.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to head-mountable display devices. More particularly, the following disclosure relates to head-mountable display devices with securement bands, display assemblies, and connectors coupling the display assemblies to the securement bands. The way in which display portions and other components of a head-mountable device are secured to a user's head can affect user comfort when donning the device. Pressures from securement bands of typical head-mountable devices on certain parts of a user's head and face over time can cause discomfort. In order to alleviate discomfort and provide an easy-to-use, adaptable donning experience, devices described herein include components and features to allow for adjustability and weight distribution leading to long-term, comfortable donning. In addition, the devices described herein can be easily adjusted to accommodate wide ranges of user head shapes and sizes without the need for individualized components or sizes to accommodate a large population of users.

Along these lines, in some examples, a head-mountable display device can include one or more side connectors extending from the securement band and cantilevering the display assembly. The display assembly can be positioned in front of the eyes of a user and configured to display visual media at a window. The head-mountable display device can further include a light source configured to display media at the window. The head-mountable display device can also include a front connector disposed between the side connectors. In some examples, the side connectors can support a greater portion of the weight relative to the front connector. The front connector can be configured to stabilize the display assembly, preventing the window at which media is displayed from bouncing, rotating, or otherwise displacing relative to the eyes of a user.

In some examples, the side connectors and the front connector can be secured to the securement band at one or more connection points. The side connectors and the front connector can be adjustable relative to the securement band. Adjustment of the side connectors and/or the front connectors can change the position of the display assembly relative the eyes of a user, allowing a user to adjust the head-mountable display device for a comfortable viewing experience. In some examples, the front connection arm and the side connection arms are translatable, rotatable, or both translatable and rotatable relative to the securement band. The side connectors can be rotatable about the one or more connection points. The front connection arm and the side connection arms can be selectively positionable, facilitating a comfortable fit of the head-mountable display device to various user head shapes.

The securement band can also be adjustable, allowing a user to change the length or tension of the securement band for comfort or securement. In some examples, the securement band can include one or more sections more rigid than other sections of the securement band. For example, the securement band can include rigid portions disposed about the connection points, preventing the securement band from deflecting or deforming while supporting the weight of the display assembly via the side connectors or the front connector. In other examples, a larger portion of the securement band can be rigid, and configured to secure the head-mounted display device to the forehead of a user. The larger rigid portion can include a facial interface or a light seal, configured to improve the comfort of the securement band. In some examples the connection of the light seal or facial interface to the larger rigid portion decouples the display from the securement band and allows for increased comfort and adjustment of the facial interface or light seal without adjustment of the display. The securement band can also include elastic portions configured to allow a user to don or doff the head-mounted display device.

In some examples, various components of the head-mountable display device can include electronic components. For example, the securement band, side connectors, front connector, or display portion can each include batteries, processors, projectors, speakers, or other electronic components. The electronic components of the head-mountable display device included in securement band, side connectors, front connector, or display portion can be in electrical communication with one another via electrical connectors. All of these features can work together to provide a useful, enjoyable, and comfortable user experience

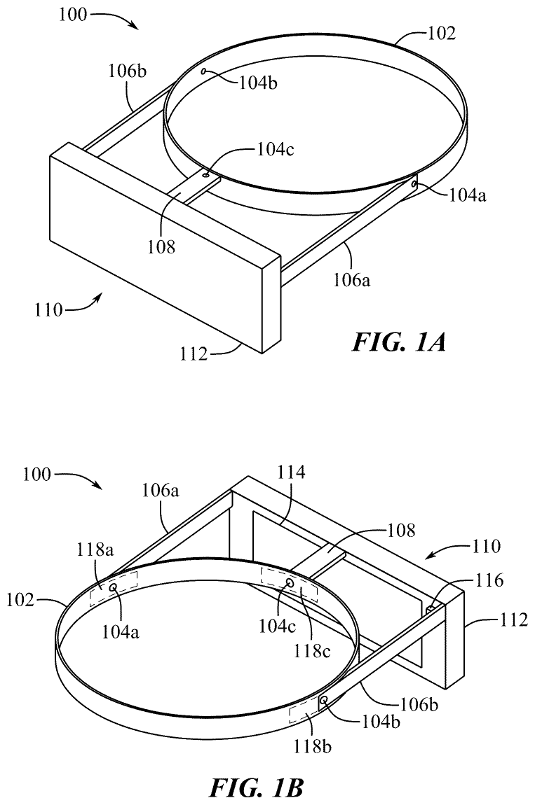

These and other embodiments are discussed below with reference to FIGS. 1-5B. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1A-1B show an example of a head-mounted display device 100. The head-mounted electronic device 100 can be an electronic display device supported by the head, cars, forehead, nose, and/or other body part of a user. In some examples, the head-mounted display device 100 can provide a user with a visual or auditory experience. The wearable electronic display device 100 can be an augmented reality device or a virtual reality device. As shown in FIG. 1A, the head-mounted display device 100 can include a securement band 102 and a display assembly 110. In some examples, the securement band 102 can be configured secure the display assembly 110 to a head of a user. The display assembly can include a frame 112. In some examples, the securement band 102 can be a closed loop. In some examples, the frame 112 can provide structural rigidity to the display assembly 110. The frame 112 can be a rigid structure to which electronic components can be mounted. In some examples, the frame 112 can be a housing. For example, the exterior structure of the display assembly can be rigid. In some examples, electronic components including processors, batteries, electrical connectors, speakers, sensors, or other electronic components can be secured to the frame 112.

In some examples, the securement band 102 can include one or more connection points 104a-c. The securement band 102 can include a first connection point 104a, and a second connection point 104b opposite the first connection point 104a. In some examples, the securement band can further include a third connection point 104c located between the first connection point 104a and the second connection point 104b. In some examples, the head-mounted display device 100 can include one or more connection arms 106a-b, 108. The connection arms 106a-b, 108 can couple the display assembly 110 to the securement band 102. In some examples, a first securement arm 106a can couple the display assembly 110 to the first connection point 104a. In some examples, a second securement arm 106b can couple the display assembly 110 to the second connection point 104b. In some examples, a third securement arm 108 can couple the display assembly 110 to the third connection point 104c. In some examples, at least one of the first securement arm 106a, the second securement arm 106b, or the third securement arm 108 can be integrally formed with the frame 112. Integral formation of the connection arms 106a-b, 108 with the frame 112 can strengthen the attachment between the connection arms 106a-b, 108 and the display assembly 110. In other examples, the connection arms 106a-b, 108 can be secured to the frame 112 via fasteners, clips, screws, or other securement methods.

As shown in FIG. 1B, the display assembly 110 can be configured to display content to a user. For example, the display assembly 110 can display videos, movies, notifications, video calls, websites, or other visual content. In some examples, the display assembly 110 can include a window 114 and a light source 116. In some examples, the window 114 can be a display, and the window 114 can be coupled to the frame 112. The light source 116 can be configured to produce content displayed at the window 114. In some examples, the window 114 can be a screen, a transparent portion, an opaque portion, or any other means of displaying visual content. In some examples, the light source 116 can be a projector, a backlight for a screen, or another light source. In some examples, the light source 116 can be separate from the window 114 and secured to the frame 112, as shown in FIG. 1B. For example, the window 114 can be a transparent portion, and the light source 116 can be a projector configured to project content on the window 114 within the field of view of a user. In other examples, the light source 116 can be disposed within or included in the window 114. For example, the window 114 can be an LCD screen, an LED screen, or an OLED screen, and the light source 116 can be the backlight for an LCD screen or the light-emitting diodes of an LED or OLED screen.

In some examples, the position of the window 114 can be adjustable relative to the securement band 102 via at least one of the first connection arm 106a, the second connection arm 106b, or the third connection arm 108. The first connection arm 106a can adjustably couple the display assembly 110 to the securement band a 102, the second connection arm 106b opposite the first connection arm 106a can adjustably couple the display assembly 110 to the securement band 102, and the third connection arm 106c can adjustably couple the display assembly 110 to the securement band 102. In some examples, the first connection arm 106a can be a first side connector, the second connection arm 106b can be a second side connector, and the third connection arm 106c can be a front connector. In some examples, the connection arms 106a-b, 108 can be adjustably coupled to the securement band 102 at the connection points 104a-c. For example, the first connection arm 106a can be can be rotatably coupled to the securement band 102 at the first connection point 104a and the second connection arm 106b can be rotatably coupled to the securement band 102 at the second connection point 104b. The display assembly 110 can be coupled to the connection arms 106a-b, and the connection arms 106a-b can be rotatable about the connection points 104a-b.

Adjustment of the connection arms 106a-b, 108 can therefore change the position of the window 114 included in the display assembly 110 relative to the securement band 102 by rotating the display assembly 110 about the connection points 104a-b via the connection arms 106a-b. In some examples, the connection arm 108 can be fixed relative to the securement band 102. In some examples, the connection arm 108 can be fixedly coupled to the securement band 102 and the display assembly 110, and can have elastic properties. For example, the connection arm 108 can be configured to allow adjustment of the display assembly 110 while being fixedly coupled to both the securement band 102 and the display assembly 110. Adjustability of the window 114 and/or the display assembly 110 relative to the securement band 102 via at least one of the first connection arm 106a, the second connection arm 106b, or the third connection arm 108 can allow a user to selectively position the window 114 to improve comfort, field of view, viewing angle, or other factors.

In other examples, the display assembly 110 can be rotatably coupled to one or more of the connection arms 106a-b, 108. For example, rotatable coupling of the display assembly 110 to the connection arms 106a-b can allow the display assembly 110 to tilt relative to the connection arms 106a-b. In some examples, rotatable coupling of the display assembly 110 to the third connection arm 108 can allow the display assembly 110 to swivel relative to the third connection arm 108. In this manner, rotatable coupling of the display assembly 110 to one or more of the connection arms 106a-b, 108 can allow a user to adjust the position of the display assembly 110 relative to a body part of the user such as the head or eyes. Adjusting the position of the display assembly 110 can also help improve comfort, field of view, viewing angle, or other factors. In yet other examples, the position of the window 114 can be adjustable relative to the securement band 102 via at least one of the connection arms 106a-b, 108, and the display assembly 110 can be rotatably coupled to one or more of the connection arms 106a-b, 108.

In some examples, at least one of the first securement arm 106a or the second securement arm 106b can cantilever the display assembly 110 from the loop defined by the securement band 102. In some examples, the window 114 can be cantilevered from the securement band 102 via the first connection arm 106a. In some examples, the window 114 can be cantilevered from the securement band 102 via the second connection arm 106b. For example, the first connection arm 106a, the second connection arm 106b, or both securement arms 106a-b can be configured to support the weight of the display assembly 110 including the window 114. The first connection arm 106a, the second connection arm 106b, or both connection arms 106a-b can also be configured to produce a moment at the respective connection points 104a, 104b, or both connection points 104a-b. The moment produced at the first connection point 104a, the second connection point 104b, or both connection points 104a-b can counteract the moment produced by the weight of the display assembly 110 acting on the arm length of the first connection arm 106a, the second connection arm 106b, or both securement arms 106a-b. In some examples where the display assembly 110 and the included window 114 are cantilevered from at least one of the connection arms 106a-b, the first connection arm 106a and the second connection arm 106b can each be configured to support a greater portion of a weight of the display assembly 110 than the third connection arm 108. In such examples, the third connection arm 108 can help stabilize the display assembly 110, support the display assembly 110 during adjustment of the connection arms 106a-b, or provide additional support.

In some examples, cantilevering the display assembly 110 from the securement band 102 via one or more connection arms 106a-b can allow for desirable placement of force on the head of a user. For example, the cantilevered connection between the display assembly 110 and the securement band 102 via the connection arms can allow the weight of the head-mounted display device 100 to be supported by a comfortable portion of the head of a user. In some examples, the weight of the head-mounted display device 100 can be disposed over the cars of a user. In some examples, cantilevering the display assembly 110 from the securement band 102 can center the force experienced by a user over the spine of a user to minimize the effort a user would exert to prevent rotation of the user's head due to the weight of the head-mounted display device 100. In some examples, placement of the force supporting the weight of the head-mounted display device 100 at or near the mid-point of the head of a user from front to back can provide a more comfortable experience, allow a user to wear the head-mounted display device 100 for longer periods of time, and prevent fatigue in the head or neck of a user.

In some examples, the securement band 102 can be at least partially reinforced. In some examples, the closed loop defined by the securement band 102 can include a first material and a second material more rigid than the first material adjacent the second material or portion of the securement band 102. The second material can be used to reinforce at least one section of the securement band 102. For example, at least one of the first connection point 104a, the second connection point 140b, or the third connection point 104c can include a second material more rigid than the first material. The inclusion of a second, more rigid, material in the securement band 102 can help the securement band 102 resist twisting, rotating, slipping, or deforming in response to the weight of the display assembly 110, force applied by a user when donning or doffing the head-mounted display device 100, or another force. For example, the inclusion of a second, more rigid, material at the first connection point 104a and the second connection point 104b can help the securement band resist twisting and deforming in response to the moment applied to the securement band 102 at the connection points 104a-b by the connection arms 106a-b supporting the display assembly 110. In some examples, the securement band 102 can include inserts 118a-c disposed at or near the connection points 104a-c and manufactured from a second, more rigid material. In some examples, the inserts 118a-c can be disposed within or encompassed by a first, less rigid, material of the securement band 102. In other examples, the inserts 118a-c can be secured to the exterior or interior of the loop defined by the securement band 102. In other examples, the securement band 102 can include a core made from the second, more rigid material and extending along the entire loop defined by the securement band 102. The core can also be disposed within or be encompassed by the first, less rigid material. In yet other examples, the core can be secured to the exterior or interior of the loop defined by the securement band 102. Any of the components of the head-mounted display device 100 can be manufactured from polymers, natural materials, metals, ceramics, or composites.

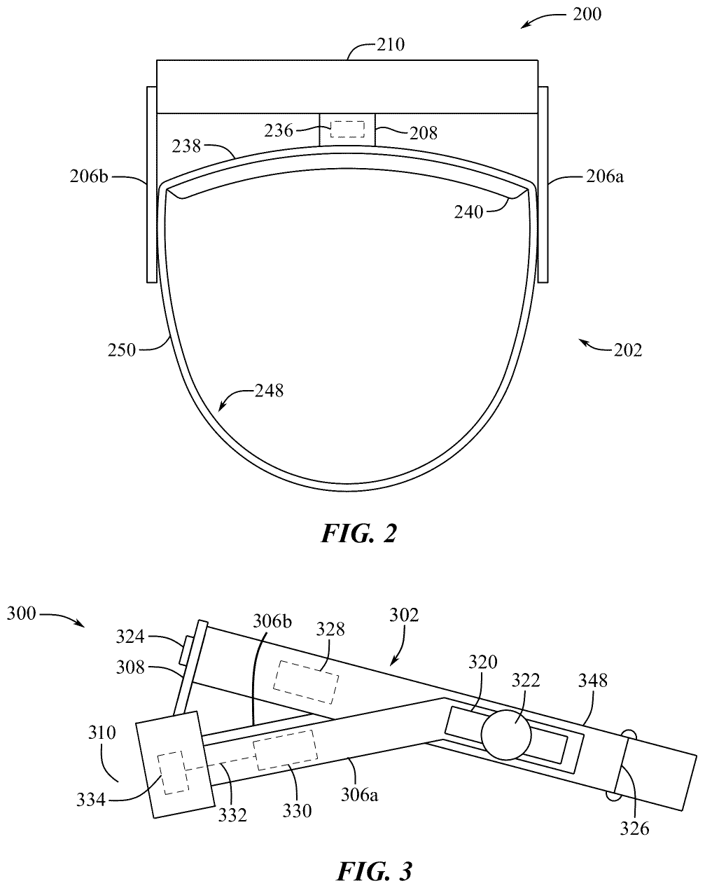

Any of the features, components, and/or parts, including the arrangements and configurations thereof shown in FIGS. 1A-1B can be included, cither alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 1A-1B. Examples of electronic display devices including securement bands, connectors, and display portions are given below in reference to FIG. 2.

FIG. 2 shows a top view of an example of an electronic display device 200. In some examples, the electronic display device 200 can be a head-mounted display device such as an augmented reality device or a virtual reality device. The electronic display device 200 can include a display portion 210 and a securement band 202. In some examples, the display portion 210 can be configured to display visual media to a user. The securement band 202 can be configured to secure the electronic display device 200 to the head of a user. The securement band 202 can include a loop 248, which can be a continuous loop. The securement band 202 can also include a first side connector 206a adjustably coupled to the loop 248 and extending to the display portion 210 a second side connector 206b adjustably coupled to the loop 248 and extending to the display portion 210, and a front connector 208 adjustably coupled to the loop 248 and extending to the display portion 210. In some examples, the second side connector 206b can be opposite the first side connector 206a, and the front connector 208 can be disposed between the first side connector 206a and the second side connector 206b. In some examples, the first side connector 206a can define a first connection 204a point along the loop 248, the second side connector 206b can define a second connection point 204b along the loop 248, and the front connector 208 can define a third connection point 204c along the loop 248. The front connector 208 can include an electronic component 236. The electronic component 236 can be a processor, a speaker, a sensor, a battery, or any other electronic component. The electronic component 236 can also be in electrical communication with one or more electrical components included in the display portion 210.

In some examples, the securement band 202 can be configured to allow a user to easily don and doff the electronic display device 200, and can provide the user with a comfortable experience while wearing the electronic display device 200. At least a portion of the securement band 202 including the third connection point 204c can be rigid. For example, the securement band 202 can include a first portion 238 and a second portion 250 more elastic than the first portion 238. The first portion 238 can be more rigid than the second portion 250, and can include the third connection point 204c. The first portion 238 can also be configured to rest on the forehead of a user. In some examples, a user can hold the first portion 238 and pull on the second portion 250 to expand the loop 248 and facilitate easier donning and doffing of the electronic display device 200.

In some examples, the first portion 238 can further include a facial interface 240 extending from the securement band 202. The facial interface 240 can be configured to contact the face of a user. In some examples, the facial interface 240 can be made from silicone, foam, rubber, or another material that can conform to the contours of a user's face. The facial interface 240 can provide a user with a comfortable experience by distributing the force applied by the securement band 202. The facial interface 240 can also include breathable qualities to prevent sweat build-up and allow the face of a user to stay cool. In some examples, the facial interface 240 can function as a light-seal. The facial interface 240 can prevent light from outside the electronic display device 200 from entering the field of view of a user. In this manner, the facial interface can prevent external light sources or other factors from distracting a user while using the electronic display device 200.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2. More examples of head-mounted display devices including adjustable connectors, electronic components, and adjustable securement bands are described in reference to FIG. 3.

FIG. 3 shows a side view of an example of a head-mounted display device 300. The head-mounted display device 300 can be adjustable in a myriad of ways, allowing a user to change the geometry, fit, and tensions of the head-mounted display device 300 to better conform to the user's head and to facilitate a comfortable user experience. For example, the head-mounted display device 300 can include an adjustable securement band 302. In some examples, a tension of the securement band 302 can be adjustable. The securement band 302 can include an adjustment mechanism 226. In some examples, the adjustment mechanism 326 can be configured to change a tension of the securement band 302. The adjustment mechanism 326 can be a sliding adjustment mechanism, a dial, a cord cinch, or any other adjustment mechanism. In some examples, the adjustment mechanism 326 can be an electronic adjustment mechanism. In some examples, the securement band 302 can have a first length when not secured to the head of a user, and the adjustment mechanism 326 can change the length of the securement band when not secured to the head of a user. A user can increase or maximize comfort of the head-mounted display device 300 by changing the length of the securement band 302 or a tension of the securement band 302 via the adjustable mechanism 326.

In some examples, the securement band 302 can include a loop 348, a first side connector 306b adjustably coupled to the loop 348 and extending to the display portion 310 and a front connector 308 adjustably coupled to the loop 348 and extending to the display portion 310. The first side connector 306a, the second side connector 306b, and the front connector can be coupled to the display portion 310. In some examples, the securement band 302 can also include a second side connector 306b opposite the first side connector 306a. In some examples, the loop 348 can include an electronic component 328. At least one of the first side connector 306a, the second side connector 306b, or the front connector 308 can include an electronic component 230. The display portion 310 can also include an electronic component 334. Any of the electronic components 328, 330, or 334 can be in electronic communication with one another via one or more electrical connectors 332. The electronic components 328, 330, and 334 can each be a processor, a battery, a speaker, a sensor, a light source, or any other electronic component. For example, the electronic component 330 can be a speaker in electronic communication via the electrical connector 332 with the electronic component 334, which can be a processor.

In some examples, the first side connector 306a, the second side connector 306b, and the front connector 308 can each be adjustable relative to the securement band 302 and therefore allow a user to further adjust the fit of the head-mounted display device 300 for maximum comfort. The first side connector 306a and the second side connector 306b can each be translatable in a first direction relative to the securement band 302. In some examples, the front connector 308 can be translatable in a second direction substantially perpendicular to the first direction relative to the securement band 302. The first direction can be along the loop 348 of the securement band 302, and the second direction can be perpendicular to the loop 348. Translation of the first side connector 306a and the second side connector 306b can change the position of the display portion 310 relative to the securement band 302, and relative to the face or eyes of a user. Changing the distance of the display portion 310 relative to the securement band 302 and the eyes of a user can allow the eyes of a user to focus more easily and more comfortably on media displayed by the display portion. Additionally, changing the distance of the display portion 310 relative to the securement band 302 and the eyes of a user can change the perceived size of media displayed to a user by the display portion 310. This can prevent the eyes of a user from tiring, extend the amount of time a user can comfortably user the head-mounted display device 300, and compensate for different focal lengths of the eyes of different users.

In some examples, translation of the front connector 308 relative to the securement band 302 can change the position of the display portion 310 relative to the eyes of a user. For example, an adjustment of the front connector 308 can change an angle of the display portion 310 relative to the loop 348. Changing the angle of the display portion 310 relative to the loop 348 can move the position of media displayed by the display portion 310 up or down within the field of view of a user. By changing the position of media displayed by the display portion 310 relative to the field of view of a user, the head-mounted display device 300 can be configured to comfortably display media to users with a variety of different head shapes, eye positions, and facial structures. In some examples, the first side connector 306a and the second side connector 306b can be rotatable and translatable relative to the securement band 302. For example, the first side connector 306a and the second side connector 306b can each include a slot 220. The slot 220 can allow both rotation and translation of the first side connector 306a and the second side connector 306b relative to the securement band 302. In some examples, the first side connector 306a and the second side connector 306b can be secure to the securement band 302 via a side securement mechanism 322.

The side securement mechanism 322 can selectively prevent or enable translation or rotation of the first side connector 306a relative to the securement band 302. The side securement mechanism 322 can extend through the slot 320, and the side securement mechanism 322 can slide along the slot 320 relative to the first side connector 306a. In some examples, the side securement mechanism 322 can allow adjustability along a continuous length or set of angles. In other examples, the side securement mechanism 322 can allow adjustment between one or more discrete longitudinal or angular positions. In some examples, the discrete longitudinal or angular positions can be defined by detent features of the side securement mechanism 322 or the slot 320. The side securement mechanism 322 can be a dial, a pin, a protrusion, or any other securement mechanism. In some examples, the side securement mechanism 322 can also be electrically driven. The front connector can also include a front securement mechanism 324. The front securement mechanism 324 can be substantially similar to the side securement mechanism 322.

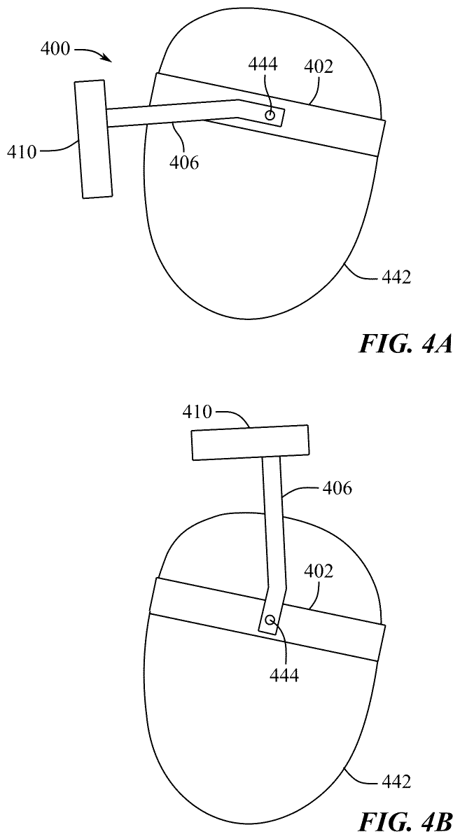

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3. Further examples of adjustable head-mounted display devices are given below in reference to FIGS. 4A-4B.

FIGS. 4A-4B show an example of a head-mounted display device 400 in different positions. The head-mounted display device 400 can include a securement band 402 securing the head-mounted display device 400 to a head 442 of a user. The head-mounted display device 400 can also include a display assembly 410 and at least one connection arm 406 coupling the display assembly to the securement band 402. In some examples, the connection arm 406 and the display assembly 410 can be rotatable about a connection point 444 on the securement band 402 relative to the head 442 of a user. FIG. 4A shows the head-mounted display device 400 in a first position. In the first position, the display assembly 410 can be disposed within the field of view of a user and can be configured to display media. FIG. 4B shows the head-mounted display device 400 in a second position. In the second position, the display assembly 410 can be removed from the view of a user. In some examples, the display assembly 410 can be disposed over the top of the head 442 of a user in the second position as shown. In other examples, the display assembly 410 can be disposed below the field of view of a user in the second position. The display assembly 410 and the connection arm 406 can be rotated relative to the head of a user to transition from the first position to the second position, or from the second position to the first position.

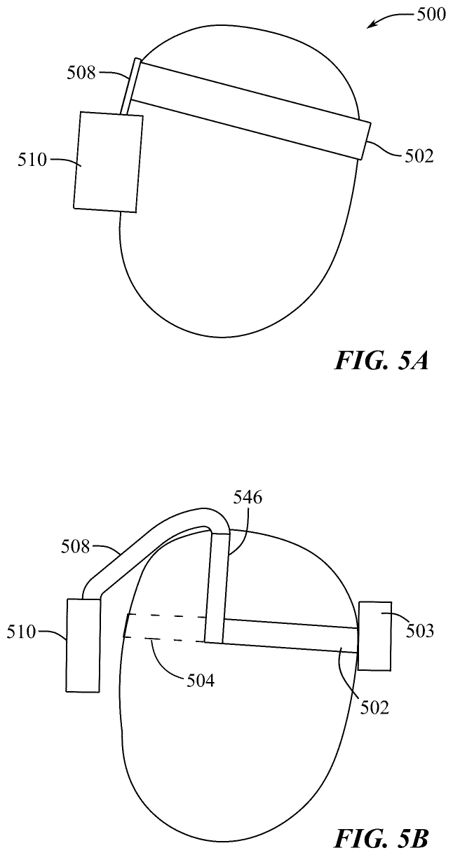

Any of the features, components, and/or parts, including the arrangements and configurations thereof shown in FIGS. 4A-4B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 4A-4B. Other embodiments of electronic display devices are described in reference to FIGS. 5A-5B.

FIGS. 5A-5B show examples of an electronic display device 500. The electronic display device 500 shown in FIGS. 5A-5B can be secured to the head of a user. The electronic display device 500 can include a securement band 502, a display portion 510, and one or more front connectors 508 coupling the display portion 510 to the securement band 502. FIG. 5A shows the electronic display device 500 with the display portion 510 suspended from the securement band 520 via the one or more front connectors 508. In some examples, suspension of the display portion 510 from the securement band 502 can allow the peripheral vision of a user to be unobstructed. An unobstructed peripheral view can allow a user to more easily interact with objects or people around the user, and allow the user to detect external hazards. In this manner, suspension of the display portion 510 from the securement band 502 can facilitate a more blended experience of reality and media displayed by the display portion 510, while improving safety.

FIG. 5B shows the electronic display device 500 further including a crown 546. In some examples, the crown 546 can couple the securement band 502 to the front connector 508. As shown in FIG. 5B, the securement band 502 can extend around a portion of the head of a user and be coupled to the crown 546. The crown can extend up the head of a user and be coupled to the front connector 508. The front connector 508 can extend down the front of the head of a user, and suspend the display portion 510 in the field of view of a user. The crown 546 can change allow the securement band 502 to extend around only a portion of the head of a user, thus allowing the forehead, temples, or other body parts of a user to be free from forces exerted by the securement band 502. In some examples, the inclusion of the crown 546 can prevent the forehead, temples, or other body part of a user from becoming fatigued or sweating. In this manner, the electronic display device 500 shown in FIG. 5B can help facilitate a comfortable user experience. In such an example, a counterweight 503 can be secured to a back portion of the securement band 502 to evenly distribute weight on the user's head and counterbalance a weight of the display portion 510. In one or more examples, the counterweight 503 can include a component of the device, including a functional component such as a batter, processor, antenna, or other electronic component of the device. In one example, the counterweight 503 can include a non-functional component such as a mass of material for weighting purposes. Additionally, an optional front band 504 is illustrated if additional support or user contact is desired, which can be included with or without the counterweight 503.

Any of the features, components, and/or parts, including the arrangements and configurations thereof shown in FIGS. 5A-5B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 5A-5B.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, X® (formerly TWITTER®) ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A head-mounted display device, comprising:
a display assembly including:
a window; and
a light source configured to produce content displayed at the window;
a securement band defining a closed loop, the closed loop including:
a first connection point;
a second connection point opposite the first connection point; and
a third connection point disposed between the first connection point and the second connection point;
a first connection arm coupling the display assembly to the first connection point;
a second connection arm coupling the display assembly to the second connection point; and
a third connection arm coupling the display assembly to the third connection point.

2. The head-mounted display device of claim 1, wherein a first portion of the securement band including the third connection point is more rigid than a second portion of the securement band adjacent the first portion.

3. The head-mounted display device of claim 1, wherein a position of the window is adjustable relative to the securement band via at least one of the first connection arm, the second connection arm, or the third connection arm.

4. The head-mounted display device of claim 1, wherein the display is cantilevered from the securement band via the first connection arm.

5. The head-mounted display device of claim 4, wherein the display is cantilevered from the securement band via the second connection arm.

6. The head-mounted display device of claim 1, wherein a tension of the securement band is adjustable.

7. The head-mounted display device of claim 1, wherein:
the closed loop includes a first material; and
at least one of the first connection point, the second connection point, or the third connection point includes a second material more rigid than the first material.

8. The head-mounted display device of claim 1, further including a light seal extending from the securement band.

9. A securement band for a head-mounted display device, comprising:
a loop;
a first side connector adjustably coupled to the loop and extending to a display;
a second side connector adjustably coupled to the loop and extending to the display; and
a front connector adjustably coupled to the loop and extending to the display;
wherein:
the second side connector is disposed opposite the first side connector; and
the front connector is disposed between the first side connector and the second side connector.

10. The securement band of claim 9, wherein the loop comprises a continuous loop.

11. The securement band of claim 9, wherein the loop comprises:
a first portion; and
a second portion more elastic than the first portion.

12. The securement band of claim 9, wherein the loop comprises an electronic component.

13. The securement band of claim 9, wherein at least one of the first side connector or the second side connector cantilevers the display from the loop.

14. The securement band of claim 9, wherein an adjustment of the front connector changes an angle of the display relative to the loop.

15. The securement band of claim 9, wherein at least one of the first side connector, the second side connector, or the front connector comprises an electronic component.

16. An electronic display device, comprising:
a display assembly including a frame and a display coupled to the frame;
a securement band configured secure the display assembly to a head;
a first side connector adjustably coupling the display assembly to the securement band;
a second side connector opposite the first side connector, the second side connector adjustably coupling the display assembly to the securement band; and
a front connector adjustably coupling the display assembly to the securement band.

17. The electronic display device of claim 16, wherein the first side connector and the second side connector are each translatable in a first direction relative to the securement band.

18. The electronic display device of claim 17, wherein the front connector is translatable in a second direction substantially perpendicular to the first direction relative to the securement band.

19. The electronic display device of claim 16, wherein the first side connector and the second side connector are each configured to support a greater portion of a weight of the display assembly than the front connector.

20. The electronic display device of claim 16, wherein the first side connector and the second side connector are rotatable and translatable relative to the securement band.
